(19) United States
(12) Patent Application Publication
(10) Pub. No.: US 2007/0037929 A1
(43) Pub. Date: Feb. 15, 2007

(54) Highly elastic polyvinyl chloride composition and products prepared using the same

(76) Inventors: Munkyu Joo, Busan-city (KR); Youngjin Kim, Daejeon-City (KR); Dongjoo Kwon, Daejeon-City (KR); Wook Jang, Daejeon-City (KR)

Correspondence Address: CANTOR COLBURN, LLP, 55 GRIFFIN ROAD SOUTH, BLOOMFIELD, CT, 06002, US

(21) Appl. No.: 11/501,385

(22) Filed: Aug. 9, 2006

(30) Foreign Application Priority Data
Aug. 11, 2005 (KR) 10-2005-0073953
Apr. 26, 2006 (KR) 10-2006-0037656

(51) Int. Cl. C08F 8/00

(52) U.S. Cl. 525/191

(57) ABSTRACT

A highly elastic polyvinyl chloride composition comprises polyvinyl chloride-rubber particles including rubber particles and secondary polyvinyl chloride particles formed by combination of primary polyvinyl chloride particles. In the polyvinyl chloride-rubber particles, pores between primary polyvinyl chloride particles that form secondary polyvinyl chloride particles are filled with rubber particles. A film manufactured using the polyvinyl chloride composition has high elasticity, and rubber particles contained in the film have high uniformity. In addition, by using cross-linked rubber particles, the polyvinyl chloride composition may show high elongation, large tensile strength, and excellent processability due to no increase in viscosity even when the content of plasticizer used is not increased during a film formation process.

This application claims priority to Korean Patent Application Nos. 10-2005-0073953, filed on Aug. 11, 2005, and 10-2006-0037656, filed on Apr. 26, 2006 in the Korean Intellectual Property Office, and all the benefits accruing therefrom under 35 U.S.C. §119, and the contents of which in its entirety are herein incorporated by reference.

### BACKGROUND OF THE INVENTION

1. Field of the Invention

The present invention relates to a highly elastic polyvinyl chloride composition and highly elastic products prepared using the same, and more particularly, to a polyvinyl chloride composition that has large tensile strength, high elongation, and high processability due to low viscosity resulting from being cross-linked and a film prepared using the same.

2. Description of the Related Art

Polyvinyl chloride resins are prepared by polymerizing monomers, such as vinyl chloride. In order to produce polyvinyl chloride products, polyvinyl chloride resins are blended with additives, such as plasticizers, coloring agents, and thermal stabilizers, and then subjected to molding processes, such as extrusion processes, calendar processes, transferring processes, dipping processes, etc. Soft polyvinyl chloride, which contains a plasticizer, can be used in a wide range of applications, such as construction materials, toys, artificial feathers, shoes, and gloves, according to the processing method used.

Meanwhile, conventionally, soft resin products are used in, in particular, automobile interiors. In order to obtain a cushioning property, surface materials of automobile interior products are primarily formed of soft polyvinyl chloride that is disposed on a foam layer, such as polyolefin or polyurethane. However, films formed having soft polyvinyl chloride as a surface material have lower elasticity than films formed of natural rubber or other rubbers.

In order to increase elasticity, Korean Patent Publication No. 2001-52916 discloses an elastic foam layer that contains polyvinyl chloride and acrylonitrile butadiene rubber(NBR) or styrene butadiene rubber(SBR), and a bottom decorator prepared using the same. In this case, the mixing of polyvinyl chloride and NBR or butadiene rubber(BR) is performed by simply mixing respective components powder and stirring them at high temperature to form a film. Accordingly, the manufacturing process requires excessive thermal energy and the composition in the film prepared has low uniformity. As a result, elongation and restorability of the film decreases in addition, when the composition prepared as described above is formed into a film by an extrusion process or a calendaring process, it is difficult to obtain a film having a thickness of 300 μm or less. Furthermore, the composition is not suitable for formation of a three-dimensional film product, such as vinyl gloves. Due to these problems, the composition prepared as described above has poor processability.

U.S. Pat. No. 6,333,386 discloses a rubber composition that is used to form a hose, the composition containing NBR that has 43-50% of acrylonitrile, polyvinyl chloride (PVC), and a plasticizer having a solubility parameter (SP) of 8.8 or more and an average molecular weight of 550. In this case, however, the content of the PVC is as low as 25-40% and the content of NBR is too high, so that during a process of blending, it is difficult to prepare a plastisol that uses plasticizer due to the presence of large particles. Accordingly, the rubber composition is not suitable for a soft product manufacturing process, such as a dipping process. In addition, the rubber composition is not suitable for formation of products such as thin gloves.

U.S. Pat. No. 6,043,318 discloses a method of preparing a liquid-phase NBR/PVC blend, the method comprising: coating a polyvinylchloride resin with a stabilizer to form a precoated PVC; blending the precoated PVC with NBR resin; and applying heat and pressure. In this case, however, although the blended resin can be formed into a film by an extrusion process and a calendar process, it is difficult to form a plastisol and thus, a homogenous, thin film cannot be obtained.

In addition, polyvinyl chloride resin has high miscibility with respect to plasticizers, such as dioctylphthalate(DOP), dibutyl phthalate(DBP), dioctyladipate (DOA), and diisononylphthalate(DINP), with which the rubber that has been mixed is mixed during the preparation process. As a result, during the product manufacturing process, viscosity is substantially increased due to the expansion of the rubber, so that it is difficult to produce products having specific desired shapes. In order to address this problem, a large amount of plasticizer is required, which is disadvantageous.

### BRIEF SUMMARY OF THE INVENTION

The present invention provides a highly elastic polyvinyl chloride composition that has high elongation, large tensile strength, and high processability due to no increase of viscosity even when the content of plasticizer used is not increased during a film manufacturing process.

The present invention also provides highly elastic products manufactured using the highly elasticpolyvinyl chloride composition.

According to an aspect of the present invention, there is provided a highly elastic polyvinyl chloride composition comprising polyvinyl chloride-rubber particles, the polyvinyl chloride-rubber particles comprising: secondary polyvinyl chloride particles formed by combination of primary polyvinyl chloride particles; and rubber particles, wherein the rubber particles fill pores between primary polyvinyl chloride particles that form secondary polyvinyl chloride particles.

In the highly elastic polyvinyl chloride composition, the polyvinyl chloride-rubber particles are obtained by mixing 100 parts by weight of polyvinyl chloride particles in a water-dispersible latex phase with 1-30 parts by weight of rubber particles in a water-dispersible latex phase and then drying the resultant mixture.

In the highly elastic polyvinyl chloride composition, an average degree of polymerization of the polyvinyl chloride is in the range of 100 to 3,000.

In the highly elastic polyvinyl chloride composition, an average diameter of the primary polyvinyl chloride particles may be in the range of 0.1-2 μm.

In the highly elastic polyvinyl chloride composition, the polyvinyl chloride particles can be obtained from a vinyl chloride monomer or a mixed monomer of vinyl chloride and other monomer that can be copolymerized with the vinyl chloride.

The other monomer may include at least one compound selected from the group consisting of acylic acid, etatrylic acid, alpha-cyanoacrylic acid, methylacrylate, ethylacrylate, butylacrylate, octylacrylate, cyanoethylacrylate, vinylacetate, methylmetacrylate, ethylmetacrylate, butylmetacrylate, acrylo nitrile, metacrylonitrile, methylacrylamide, N-methylacrylamide, N-butoxymetacrylamide, ethylvinylether, chloro-ethylvinylether, alpha-methylstyrene, vinyltoluene, chlorostyrene, vinylnaphthalene, vinylidenechloride, vinylbromide, vinylchloroacetate, vinylacetate, vinylpyridine, and methylvinylketone.

In the highly elastic polyvinyl chloride composition, the rubber particles can be selected from the group consisting of styrene-butadiene rubber(SBR), acrylonitrile-butadiene rubber(NBR), metacrylate-butadiene-styrene rubber(MBS), and a mixture of these.

In the highly elastic polyvinyl chloride composition, the content of butadiene contained in styrene-butadiene rubber(SBR) may be in the range of 60-90 wt %.

The content of butadiene contained in acrylonitrile-butadiene rubber(NBR) can be in the range of 50-90 wt %. The acrylonitrile-butadiene rubber(NBR) may further include 1-10 parts by weight of a monomer having a carboxylic group based on 100 parts by weight of the total content of acrylonitrile and butadiene.

The content of metacrylate contained in the metacrylate-butadiene-styrene rubber(MBS) may be in the range of 5-30 wt % and the content of butadiene is in the range of 60-90 wt %.

In the highly elastic polyvinyl chloride composition, an average degree of polymerization of the rubber particles may be in the range of 100-3,000. The average diameter of the rubber particles may be in the range of 0.05-1 μm.

The highly elastic polyvinyl chloride composition may further include 80-100 parts by weight of a plasticizer based on 100 parts by weight of polyvinyl chloride-rubber particles.

The plasticizer may include 70-90 wt % of primary plasticizer and 10-30 wt % of secondary plasticizer.

The primary plasticizer may include at least one compound selected from the group consisting of dioctyl phthalate, diisononyl phthalate, and butylbenzyl phthalate, and the secondary plasticizer may include at least one compound selected from the group consisting of 2,2,4-trimethyl-1,3-pentanediol diisobutyrate (TXIB), Hisol SAS 296 (a mixture of 1-phenyl-1-xylethane and 1-phenyl-1-ethylphenylethane), BYK-331 (polyether modified polydimethylsiloxane copolymer), and dioctylphthalate (DOP).

In the highly elastic polyvinyl chloride composition, the rubber particles can be subjected to a crosslinking treatment using a crosslinking agent.

The crosslinking treatment can be performed by adding 0.5-10 parts by weight of the solid content of the crosslinking agent to 100 parts by weight of the solid content of the rubber particles in a latex phase at a temperature ranging from 10° C. to 95° C. and stirring the reactant products.

The crosslinking agent may include at least one compound selected from the group consisting of trimethylolpropane-trimetacrylate, triarylcyanurate, triarylisocyanurate, N,N′-metaphenylenedimaleimide, ethyleneglycoldimetacrylate, vinyl-1,2-polybutadiene, 1,1-t-butylperoxy-3,3,5-trimethylcyclohexane, n-butyl-4,4-bisbutylperoxyvalerate, dicumylperoxide, benzoylperoxide, t-butylperoxybenzoate, di-t-butylperoxide, 2,5-dimethyl-2,5-di-t-butylperoxyhexane, paraquinonedioxin, dibenzoylparaquinonedioxin, tetrachloroparabenzoquinone, hexamethylenetetramine, acetaldehydeammonia, butylaldehydeammonia, butylaldehyde butylanyline, acetaldehyde anyline, diphenylguanidine, diorthotolylguanidine, orthotolylbiguanidine, N,N′-diethylthiourea, dibutylthiourea, diraurylthiourea, trimethyl-thiourea, mercaptobenzothiazole, dibenzothiazyldisulfide, sodium-2-mercapto-benzothiazole, tetramethylthiurammonosulfide, tetramethyltetramethylthiuramdisulfide, tetraethylthiuramdisulfide, tetrabutylthiuramdisulfide, dipentamethylene-thiuramtetrasulfide, sodiumdimethyldithiocarbamate, sodiumdibutyldithio-carbamate, zincdimethyldithiocarbamate, zincdiethyidithiocarbamate, pericdimethyldithiocarbamate, cupperdimethyldithiocarbamate, zincethylphenyldithiocarbamate, zincdibutyldithiocarbamate, zincbutylxanthate, zincisopropylxanthate, zincethylxanthate, sodiumisopropylxanthate, sodiumethylxanthate, potassiumethylxanthate, potassiumisopropylxanthate, N-cyclohexyl-2-benzothiazolylsufenamide, N-t-butyl-2-benzothiazolyl-sulfenamide, N-oxydiethylene-2-benzothiazoylsulfenamide, zinc oxide, zinc carbonate, magnesium oxide, plumbum monooxide, potassium hydrate, stearinic acid, oleic acid, lauric acid, stearinic acid zinc, dibutylamoniumolate, vinyltrimetoxysilane, vinyltri-etoxysilane, vinyl-tri-(2-methoxyethoxysilane), vinyltriacetoxysilane, gammamercaptoxypropyltrimetoxysilane, gammamercaptotri-(2-methoxyethoxysilane), gammaglycyldylpropyltrimetoxysilane, gammamercaptopropyltriethoxysilane, gammaaminopropyltrimetoxysilane, gammaaminopropyltrimetoxysilane, aminoalkylsilicone, styreneoxazoline, and 2-methyloxazoline.

The viscosity of the highly elastic polyvinyl chloride composition may be in the range of 500-6,000 cps at 25° C.

An average diameter of the polyvinyl chloride-rubber particles may be in the range of 10-50 μm.

According to another aspect of the present invention, there is provided a product prepared using the highly elastic polyvinyl chloride composition.

The product can be a film, a sheet, or a tile.

### BRIEF DESCRIPTION OF THE DRAWINGS

The above and other features and advantages of the present invention will become more apparent by describing in detail exemplary embodiments thereof with reference to the attached drawings in which:

FIG. 1 is a scanning electron microscopy (SEM) image of a polyvinyl chloride-rubber particle prepared according to Comparative Example 1;

FIG. 2 is a SEM image of a polyvinyl chloride-rubber particle prepared according to Example 20;

FIG. 3 is a SEM image of a central portion of a cross section of a polyvinyl chloride-rubber particle prepared according to Example 20; and

FIG. 4 is a SEM image of a surface portion of a cross section of a polyvinyl chloride-rubber particle prepared according to Example 20.

### DETAILED DESCRIPTION OF THE INVENTION

The present invention will now be described more fully with reference to the accompanying drawings.

The present invention provides a polyvinyl chloride composition that exhibits high tensile strength, high elasticity, and high processability, when being processed by a dipping process. To this end, the polyvinyl chloride composition includes polyvinyl chloride-rubber particles that are prepared, before drying polyvinyl chloride particles, by mixing rubber particles with polyvinyl chloride particles in a latex phase and then drying the resultant mixture. By mixing rubber particles with polyvinyl chloride particles in a latex phase, the resultant polyvinyl chloride-rubber particles have a novel structure in which the rubber particles are dispersed in micropores between primary polyvinyl chloride particles (in the present specification, ‘primary polyvinyl chloride particles’ refer to polyvinyl chloride mono particles dispersed in a latex phase).

A high elasticity polyvinyl chloride composition according to an embodiment of the present invention includes polyvinyl chloride-rubber particles that include secondary polyvinyl chloride particles (in the present specification, ‘secondary polyvinyl chloride particles’ refer to multiple polyvinyl chloride particles formed by combination of primary polyvinyl chloride particles) and rubber particles. In the polyvinyl chloride-rubber particles, pores between primary polyvinyl chloride particles that form secondary polyvinyl chloride particles are filled with the rubber particles.

Generally, in a process of manufacturing polyvinyl chloride particles, first initial domains are formed during a polymerization process. After the polymerization process, the first initial domains form primary particles (diameter of about 0.5-2.0 μm) and the formed primary particles are dispersed in a latex phase. Such primary particles form secondary particles (diameter of about 200-100 μm) during a drying process. When the secondary polyvinyl chloride particles are mixed with rubber particles through powder blending, it is difficult to arrange the rubber particles inside the secondary particles if all of the secondary polyvinyl chloride particles are not pulverized. That is, rubber particles primarily exist at the surface of the secondary polyvinyl chloride particles. In addition, even when rubber particles are located inside the secondary polyvinyl chloride particles, it is difficult to obtain a uniform dispersion of rubber particles in the secondary polyvinyl chloride particles.

Therefore, to realize polyvinyl chloride-rubber particles according to an embodiment of the present invention, primary polyvinyl chloride particles in a latex phase are uniformly mixed with rubber particles in a latex phase and then the mixture is dried, thereby forming secondary polyvinyl chloride particles. In this state, rubber particles can be uniformly dispersed inside the secondary polyvinyl chloride particles, and in particular, fill pores between the primary polyvinyl chloride particles.

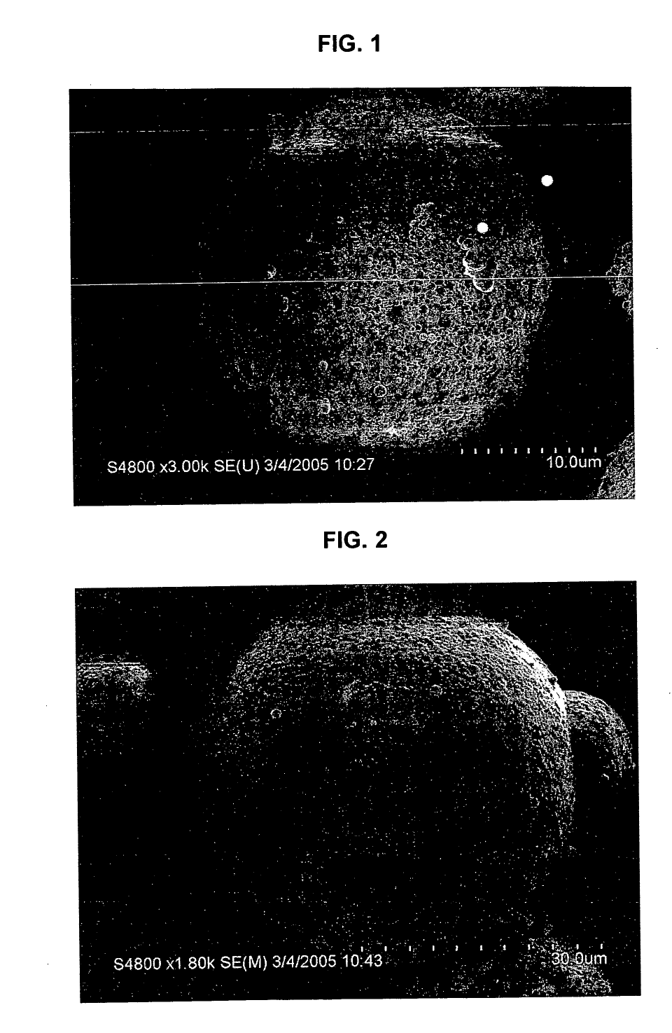

The polyvinyl chloride-rubber particles according to an embodiment of the present invention will now be described in detail with reference to FIGS. 1 and 2.

FIGS. 1 and 2 are SEM images of surfaces of polyvinyl chloride-rubber particles prepared according to Comparative Example 1 and Example 20, respectively. Referring to FIG. 1, pores are present between primary polyvinyl chloride particles, and primary polyvinyl chloride particles having an average diameter of 0.5 -2 μm form secondary polyvinyl chloride particles having a diameter of 20 μm or more. On the other hand, referring to FIG. 2, no pores are present between primary polyvinyl chloride particles. Such absence of pores may be due to small rubber particles that fill pores between primary polyvinyl chloride particles.

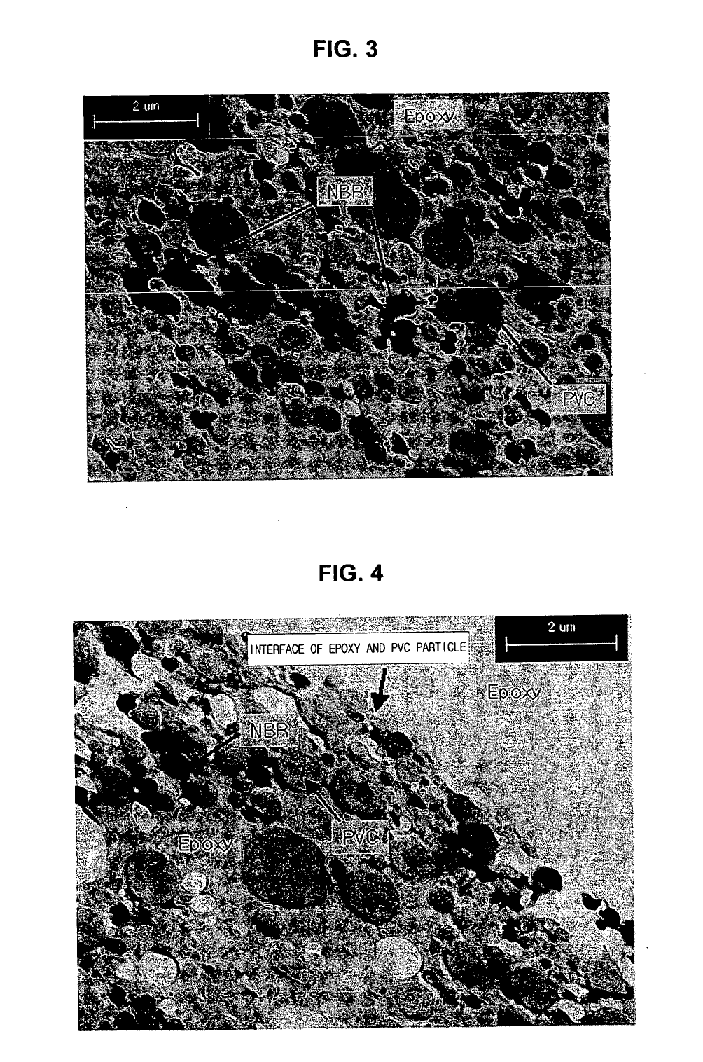

FIG. 3 is a SEM image of a central portion of a cross section of a polyvinyl chloride-rubber particle prepared according to Example 20, and FIG. 4 is a SEM image of a surface portion of a cross section of a polyvinyl chloride-rubber particle prepared according to Example 20. Referring to FIGS. 3 and 4, primary polyvinyl chloride (PVC) particles have an average diameter of about 0.5-2 μm (see gray particles in FIGS. 3 and 4), and rubber particles (NBR) have an average diameter of 300 nm or less (see black particles in FIGS. 3 and 4) and are uniformly dispersed between primary polyvinyl chloride particles. Such distribution of primary polyvinyl chloride particles and rubber particles contributes to an increase in uniformity of the composition compared to when a powder blending process is performed. Particularly, when the composition uses rubber particles that have been cross-linked and contain an additive, such as plasticizer or a thermal stabilizer, it forms a plastisol having low viscosity. As a result, such a composition can be used to form a product having various desired shapes, can be formed into a thin film having a thickness of 300 μm or less, and has high elasticity.

Properties of the composition according to an embodiment of the present invention, and ratios of components used for forming the composition, and a method of preparing the composition will now be described in detail.

Polyvinyl chloride particles according to an embodiment of the present invention can be prepared by polymerizing homo monomers of polyvinyl chloride or by polymerizing mixed monomers that include vinyl chloride and another monomer that can be copolymerized with the vinyl chloride. After the polymerization, the polymerized product can be mixed with an additive, such as plasticizer or thermal stabilizer, and then used to form a film.

An average degree of polymerization of the polyvinyl chloride particles may be in the range of 100-3,000. When the average degree of polymerization of the polyvinyl chloride particles is less than 100, the strength of a film formed of the polyvinyl chloride particles may be low. On the other hand, when the average degree of polymerization of polyvinyl chloride particles is greater than 3,000, it is difficult to polymerize vinyl chloride monomers due to properties thereof.

An average diameter of the primary polyvinyl chloride particles may be in the range of 0.1-2 μm. When the average diameter of the primary polyvinyl chloride particles is less than 0.1 μm , latex safety may be compromised when mixed with rubber water-dispersible latex. On the other hand, when the average diameter of the primary polyvinyl chloride particles is greater than 2 μm, a film made of the primary polyvinyl chloride particles may have protrusions.

The polyvinyl chloride particles can be prepared using vinyl chloride homo monomers or mixed monomers that include vinyl chloride and another monomer that can be copolymerized with the vinyl chloride according to conventional suspension polymerization, emulsion polymerization, or micro suspension polymerization. However, the present invention is not limited to these polymerizing methods.

In a micro suspension polymerization method, polymerization is performed in a micro suspension solution. In this polymerization method, at least one kind of monomer is polymerized, wherein the monomer is dispersed by a Homo mixer in an aqueous medium containing an emulsifying agent and a dispersing agent used as a stabilizer to obtain a dispersion solution of particles having an average diameter of 5 μm or less. The other monomer that can be copolymerized with the vinyl chloride can be any one that is commonly used in the art. For example, the other monomer may include at least one compound selected from the group consisting of acylic acid, metacrylic acid, alpha-cyanoacrylic acid, methylacrylate, ethylacrylate, butylacrylate, octylacrylate, cyanoethylacrylate, vinylacetate, methylmetacrylate, ethylmetacrylate, butylmetacrylate, acrylo nitrile, metacrylonitrile, methylacrylamide, N-methylacrylamide, N-butoxymetacrylamide, ethylvinylether, chloro-ethylvinylether, alpha-methylstyrene, vinyltoluene, chlorostyrene, vinylnaphthalene, vinylidenechloride, vinylbromide, vinylchloroacetate, vinylacetate, vinylpyridine, and methylvinylketone.

The rubber particles used according to an embodiment of the present invention may include at least one compound selected from styrene-butadiene rubber(SBR), acrylonitrile-butadiene rubber(NBR), metacrylate-butadiene-styrene rubber(MBS), or a mixture thereof. The rubber particles provide surface properties to a product manufactured using the polyvinyl chloride composition according to the current embodiment such as elasticity, after the product is subjected to a dipping process.

The content of rubber particles may be in the range of 1-30 parts by weight, preferably 10-20 parts by weight, and more preferably 15-20 parts by weight, based on 100 parts by weight of a solid content of the polyvinyl chloride particles. When the content of rubber particles is less than 1 part by weight, insufficient effect from mixture occurs. On the other hand, when the content of rubber particles is more than 30 parts by weight, the strength of a film formed using such a polyvinyl chloride composition may be substantially low.

When styrene-butadiene rubber (SBR) is used to form rubber particles according to an embodiment of the present invention, the content of butadiene contained in the SBR may be in the range of 60-90 wt %. When the content of butadiene contained in the SBR is less than 60 wt %, sufficient elasticity of the film cannot be obtained. On the other hand, when the content of butadiene contained in the SBR is greater than 90 wt %, compatibility of rubber particles with PVC is reduced so that a film made using such rubber particles may have low mechanical strength.

When acrylonitrile-butadiene rubber (SBR) is used to form rubber particles according to an embodiment of the present invention, the content of butadiene contained in the NBR may be in the range of 50-90 wt %. When the content of butadiene contained in the NBR rubber is less than 50 wt %, sufficient elasticity of the film cannot be obtained. On the other hand, when the content of butadiene contained in the NBR rubber is greater than 90 wt %, compatibility of rubber particles with PVC is reduced so that a film made using such rubber particles may have low mechanical strength.

Furthermore, when NBR rubber is used, during polymerization, 1-20 parts by weight of a monomer having a carboxylic group acrylonitrile based on 100 parts by weight of the total content of acrylonitirle and butadiene can be used to produce a tert-polymer. When the content of the monomer having a carboxylic group is less than 1 part by weight, no effect occurs from the addition. On the other hand, when the content of the monomer having carboxylic group is greater than 20 parts by weight, agglomeration may occur when the monomer having a carboxylic group is mixed with PVC latex.

The monomer having a carboxylic group is not limited, and can be acryltic acid, metacrylic acid, anhydrous maleic acid, or the like.

When metacrylate-butadiene-styrene (MBS) rubber is used to form rubber particles according to an embodiment of the present invention, the content of metacrylate contained in the MBS rubber may be in the range of 5-30 wt %. When the content of metacrylate contained in the MBS rubber is less than 5 wt %, compatibility of rubber particles with PVC may be reduced. On the other hand, when the content of metacrylate contained in the MBS rubber is greater than 30 wt %, sufficient elasticity of the film cannot be obtained.

The content of butadiene contained in the MBS rubber may be 60-90 wt %. When the content of butadiene contained in the MBS rubber is less than 60 wt %, sufficient elasticity of the film cannot be obtained. On the other hand, when the content of butadiene contained in MBS rubber is greater than 90 wt %, compatibility of rubber particles with PVC is reduced so that a film made using such a polyvinyl chloride composition may have low mechanical strength.

An average degree of polymerization of rubber particles may be in the range of 100-3,000. When the average degree of polymerization of rubber particles is less than 100, desired elasticity cannot be obtained. On the other hand, when average degree of polymerization of rubber particles is greater than 3,000, compatibility of rubber particles with PVC may be reduced.

An average diameter of rubber particles may be in the range of 0.05-1 μm. When the average diameter of rubber particles is less than 0.05 μm, rubber particles cannot act as a domain that provides elasticity. On the other hand, when the average diameter of rubber particles is greater than 1 μm, a film that is made using such a polyvinyl chloride composition may have low mechanical strength.

The high elasticity polyvinyl chloride composition according to an embodiment of the present invention uses rubber particles that are subjected to a cross linking process. As a result, process viscosity of the composition can be controlled and products having desired shapes can be easily produced using the composition.

A crosslinking agent that can be used in the crosslinking process can be any crosslinking agent that is commonly used in the art. For example, the crosslinking agent may include at least one compound selected from the group consisting of trimethylolpropane-trimetacrylate, triarylcyanurate, triarylisocyanurate, N,N′-metaphenylenedimaleimide, ethyleneglycoldimetacrylate, vinyl-1,2-polybutadiene, 1,1-t-butylperoxy-3,3,5-trimethyl-cyclohexane, n-butyl-4,4-bis(t-butylperoxy)pivalate, dicumylperoxide, benzoylperoxide, t-butylperoxybenzoate, di-t-butylperoxide, 2,5-dimethyl-2,5-di-t-butylperoxyhexane, paraquinonedioxin, dibenzoylparaquinonedioxin, tetrachloroparabenzoquinone, hexamethylenetetraamine, acetaldehydeammonia, butylaldehydeammonia, butylaldehyde butylaniline, acetaldehyde aniline, diphenylguanidine, diorthotolylguanidine, orthotolylbiguanidine, N,N′-diethylthiourea, dibutylthiourea, diraurylthiourea, trimethylthiourea, mercaptobenzothiazol, dibenzothiazyldisulfide, sodium-2-mercaptobenzothiazol, tetramethylthiurammonosulfide, tetramethylthiuram disulfide, tetraethylthiuramdisulfide, tetrabutylthiuramdisulfide, dipentamethylenethiuramtetrasulfide, sodiumdimethyldithiocarbamate, sodiumdibutyldithiocarbamate, zincdimethyldithiocarbamate, zincdiethyidithiocarbamate, pericdimethyldithiocarbamate, copperdimethyldithiocarbamate, zincethylphenyldithiocarbamate, zincdibutyldithiocarbamate, zincbutylxanthate, zincisopropylxanthate, zincethylxanthate, sodiumisopropylxanthate, sodiumethylxanthate, potassiumethylxanthate, potassiumisopropylxanthate, N-cyclohexyl-2-benzothiazoylsulfenamide, N-t-butyl-2-benzothiazoylsulfenamide, N-oxydiethylene-2-benzothiazoylsufenamide, zinc oxide, zinc carbonate, magnesium oxide, plumbum monooxide, potassium hydrate, stearinic acid, oleic acid, lauric acid, stearinic acid zinc, dibutylamoniumolate, vinyltrimetoxysilane, vinyltri-etoxysilane, vinyl-tri-(2-methoxyethoxysilane), vinyltriacetoxysilane, gammamercaptoxypropyltrimetoxysilane, gammamercaptotri-(2-methoxyethoxysilane), gammaglycyldylpropyltrimetoxysilane, gammamercaptopropyltriethoxysilane, gammaaminopropyltrimetoxysilane, gammaaminopropyltrimetoxysilane, aminoalkylsilicone, styreneoxazoline, and 2-methyloxazoline.

The cross-linked rubber particles used according to an embodiment of the present invention can be prepared as follows. The crosslinking agent is prepared as a 10% aqueous solution or a water-dispersible solution. Then, 0.5-10 parts by weight of a solid content of the crosslinking agent is slowly added to 100 parts by weight of a solid content of rubber in a latex phase at a temperature in a rang of 10° C. and 95° C., and then mixed for about 30 minutes. At this time, when the content of the crosslinking agent is less than 0.5 parts by weight, no effect occurs. On the other hand, when the content of the crosslinking agent is greater than 10 parts by weight, the rubber can be rather hardened and thus the desired effects of the crosslinking treatment are reduced.

Polyvinyl chloride-rubber particles used according to an embodiment of the present invention are prepared by mixing primary polyvinyl chloride particles in a water-dispersible latex phase with rubber particles in a water-dispersible latex phase when polymerization of primary polyvinyl chloride particles is complete and the primary polyvinyl chloride particles are in a water-dispersible latex phase which has not yet dried, and drying the latex.

In this case, the drying method can be any drying method that is commonly used in the art, and can be a spray dry method, a nozzle ejection dry method, or a freeze vacuum dry method.

An average diameter of polyvinyl chloride-rubber particles may be in the range of 10 μm-50 μm. When the average diameter of polyvinyl chloride-rubber particles is less than 10 μm, sufficient elasticity cannot be obtained, and process viscosity is high. On the other hand, when the average diameter of polyvinyl chloride-rubber particles is greater than 50 μm, a film that is made using a polyvinyl chloride composition comprising such polyvinyl chloride-rubber particles may have protrusions.

The polyvinyl chloride composition according to an embodiment of the present invention may include, in addition to the polyvinyl chloride-rubber particles, a plasticizer, a thermal stabilizer, and the like to form a plastisol.

The plasticizer can be any plasticizer that is commonly used in the art, and can be one selected from the group consisting of adipic acid, dimethyl adipate, diethyl adipate, di-n-butyl adipate, diisobutyl adipate, di-n-hexyl adipate, di(1,3-dimethylbutyl)adipate, di-2-ethylhexyl adipate, diisooctyl adipate, dicapryl, adipate, heptyl nonyl adipate, diisononyl adipate, di-n-octyl-n-decyl adipate, diisodecyl adipate, dicyclohexyl adipate, benzyl octyl adipate, dibutoxyethyl adipate, bis(2,2,4-trimethyl-1,3-pentanediol monoisobutyl)adipate, adipate that contains bis(4-chlorobutyl)adipate and diisohexyl adipate, 2,2,4-trimethyl-1,3-pentandioldiisobutyrate, amidester, azelate, benzoate, benzotriazole, ester, ether, brasylate, carbonate, citrate, epoxy compound, glutarate, glycerol ester, glycol ester, glycol, glycolate, hexahydrophthalate, hydrocarbonate, isobutylate, isophthalate, isosebacate, ketone, nitro compound, oleite, palmitate, pentaeritritol, phosphate, phosphite, phthalate, polyester and polymerizable plasticizer, pyrromelitate, ricinolate, salicylate, sebacate, stearate, succineate, sucross derivatives, sulfonamide, sulfoneate, sulfone, tartrate, terephthalate, terehydrophthalate, thiantrene, trimelitate, terpene, and derivatives thereof.

In the present invention, at least one plasticizer can be used. A primary plasticizer that acts as a softener and provides flexibility can be a phthalate based plasticizer, such as dioctyl phthalate, diisononyl phthalate, and butylbenzyl phthalate. A secondary plasticizer that acts as a viscosity decreasing agent can be 2,2,4-trimethyl-1,3-pentanedioldiisobutyrate, Hisol SAS 296 (a mixture of 1-phenyl-1-xylethane and 1-phenyl-1-ethylphenylethane), or BYK-331 (a polyeter modified polydimethylsiloxane copolymer).

The content of the total amount of plasticizer may be in the range of 80-100 parts by weight based on 100 parts by weight of polyvinyl chloride-rubber particles. Particularly, the content of the primary plasticizer may be in the range of 70-90 parts by weight, and the content of the secondary plasticizer may be in the range of 10-30 parts by weight, based on 100 parts by weight of polyvinyl chloride-rubber particles.

When the content of the primary plasticizer is less than 70 parts by weight, during the manufacturing process, the viscosity of a corresponding plastisol is high and a produced film has poor flexibility. On the other hand, when the content of the primary plasticizer is greater than 90 parts by weight, the mechanical properties of an obtained film are inadequate. In addition, when the content of the secondary plasticizer is less than 10 parts by weight, the viscosity of plastisol is high. On the other hand, when the content of the secondary plasticizer is greater than 30 parts by weight, the mechanical properties of the obtained film can be deteriorated.

The thermal stabilizer used according to an embodiment of the present invention can be any stabilizer that is commonly used in the art. Particularly, the thermal stabilizer may include at least one stabilizer selected from a metal salt-based thermal stabilizer, such as a tin-based stabilizer, a Ca—Zn based thermal stabilizer, and a hydrotalsite-based thermal stabilizer; a zeolite based thermal stabilizer; and an epoxy based thermal stabilizer. The content of the thermal stabilizer may be 1-4 parts by weight based on 100 parts by weight of secondary polyvinyl chloride particles.

When the polyvinyl chloride composition that includes the cross-linked rubber particles further includes 80-100 parts by weight of a plasticizer based on 100 parts by weight of polyvinyl chloride-rubber particles, the viscosity of the polyvinyl chloride composition may be in the range of 500-6000 cps at 25° C. In this state, the primary plasticizer may be dioctylphthalate(DOP) in an amount of 70-90 parts by weight, and the secondary plasticizer may be 2,2,4-trimethyl-1,3-pentanediol diisobutyrate(2,2,4-trimethyl-1,3-pentanediol diisobutyrate; TXIB) in an amount of 10-30 parts by weight. When the viscosity of the polyvinyl chloride composition is less than 500 cps at 25° C., it is difficult to control the thickness of a film formed during a dipping process due to insufficient viscosity. On the other hand, when the viscosity of the polyvinyl chloride composition is greater than 6,000 cps, workability of the composition is low.

According to an embodiment of the present invention, the polyvinyl chloride composition that can be used to manufacture highly elastic polyvinyl chloride products having great tensile strength is provided. Examples of the products are a film, a sheet, or a tile.

A high elasticity film according to an embodiment of the present invention can be manufactured using a plastisol of the polyvinyl chloride composition described above formed using a dipping process.

In particular, 80-120 parts by weight of a plasticizer and 1-4 parts by weight of a thermal stabilizer are added to 100 parts by weight of dried highly elastic secondary polyvinyl chloride particles, and then mixed for 10-30 minutes using a mixer. Then, the mixture is coated to a thickness of 100-200 μm and then dried at 180-200° C. for 3-7 minutes to form a film.

The present invention will be described in further detail with reference to following examples. These examples are for illustrative purposes only and are not intended to limit the scope of the present invention.

### EXAMPLES

### Example 1

100 parts by weight of primary polyvinyl chloride particles having an average degree of polymerization of 1,000 and an average diameter of 1 μm were mixed with 10 parts by weight of acrylonitrile-butadiene rubber (NBR) in a water-dispersible latex phase that contains 60 wt % of butadiene and has an average diameter of 1 μm, and then the mixture was dried using a spray dry method, thereby obtaining secondary polyvinyl chloride particles having an average diameter of 10 μm. Subsequently, 100 parts by weight of the secondary polyvinyl chloride particles were uniformly mixed with 80 parts by weight of dioctylphthalate (DOP) used as a primary plasticizer, 20 parts by weight of 2,2,4-trimethyl-1,3-pentanediol diisobutyrate(2,2,4-trimethyl-1,3-pentanediol diisobutyrate; TXIB), and 3 parts by weight of a metal salt based thermal stabilizer (Zinc Stearate, Songwon Industrial Co., Ltd, SZ210) using a mixer for 10 minutes, thereby obtaining a plastisol. The obtained plastisol was coated on a separator to a thickness of 0.2 mm. The coated plastisol was baked in an oven at 200° C. for 1 minute to obtain a film.

### Example 2

A film was manufactured in the same manner as in Example 1, except that 100 parts by weight of primary polyvinyl chloride particles having an average degree of polymerization of 100 and an average diameter of 0.1 μm was used.

### Example 3

A film was manufactured in the same manner as in Example 1, except that 100 parts by weight of primary polyvinyl chloride particles having an average degree of polymerization of 2,000 and an average diameter of 2 μm were mixed with 10 parts by weight of water-dispersible acrylonitrile-butadiene rubber (NBR) in a latex phase that had particles having an average diameter of 0.05 μm.

### Example 4

A film was manufactured in the same manner as in Example 1, except that 10 parts by weight of water-dispersible acrylonitrile-butadiene rubber (NBR) in a latex phase that contains 180 wt % of butadiene was used to form secondary polyvinyl chloride particles, and then 100 parts by weight of the secondary polyvinyl chloride particles were mixed with 90 parts by weight of dioctylphthalate (DOP) used as primary plasticizer and 10 parts by weight of 2,2,4-trimethyl-1,3-pentanediol diisobutyrate(2,2,4-trimethyl-1,3-pentanediol diisobutyrate; TXIB) used as secondary plasticizer to form a plastisol.

### Example 5

A film was manufactured in the same manner as in Example 1, except that 20 parts by weight of acrylonitrile-butadiene rubber (NBR) in a water-dispersible latex phase was used.

### Example 6

A film was manufactured in the same manner as in Example 4, except that 20 parts by weight of acrylonitrile-butadiene rubber (NBR) in a water-dispersible latex phase was used.

### Example 7

A film was manufactured in the same manner as in Example 1, except that 5 parts by weight of acrylonitrile-butadiene rubber (NBR) in a water-dispersible latex phase was used.

### Example 8

A film was manufactured in the same manner as in Example 1, except that 30 parts by weight of acrylonitrile-butadiene rubber (NBR) in a water-dispersible latex phase was used.

### Example 9

A film was manufactured in the same manner as in Example 1, except that 10 parts by weight of styrene-butadiene rubber (SBR) in a water-dispersible latex phase that contained 60 wt % of butadiene and had an average diameter of 1 μm was used instead of acrylonitrile-butadiene rubber (NBR).

### Example 10

A film was manufactured in the same manner as in Example 1, except that 10 parts by weight of styrene-butadiene rubber (SBR) in a water-dispersible latex phase that contained 80 wt % of butadiene and had an average diameter of 1 μm was used instead of acrylonitrile-butadiene rubber (NBR).

### Example 11

A film was manufactured in the same manner as in Example 1, except that 20 parts by weight of water-dispersible styrene-butadiene rubber (SBR) in a latex phase that contained 60 wt % of butadiene and had an average diameter of 1 μm was used instead of acrylonitrile-butadiene rubber (NBR).

### Example 12

A film was manufactured in the same manner as in Example 1, except that 20 parts by weight of styrene-butadiene rubber (SBR) in a water-dispersible latex phase that contained 80 wt % of butadiene and had an average diameter of 1 μm was used instead of acrylonitrile-butadiene rubber (NBR) to prepare secondary polyvinyl chloride particles, and 70 parts by weight of dioctylphthalate (DOP) used as primary plasticizer and 30 parts by weight of 2,2,4-trimethyl-1,3-pentanediol diisobutyrate (2,2,4-trimethyl-1,3-pentanediol diisobutyrate; TXIB) used as secondary plasticizer, based on 100 parts by weight of the obtained secondary polyvinyl chloride, were used to prepare a plastisol.

### Example 13

A film was manufactured in the same manner as in Example 1, except that 5 parts by weight of styrene-butadiene rubber (SBR) in a water-dispersible latex phase that contained 60 wt % of butadiene and had an average diameter of 1 μm was used instead of acrylonitrile-butadiene rubber (NBR).

### Example 14

A film was manufactured in the same manner as in Example 1, except that 10 parts by weight of metacrylate-butadiene-styrene rubber (MBS) in a water-dispersible latex phase that contained 60 wt % of butadiene and had an average diameter of 1 μm was used instead of acrylonitrile-butadiene rubber (NBR).

### Example 15

A film was manufactured in the same manner as in Example 1, except that 10 parts by weight of metacrylate-butadiene-styrene rubber(MBS) in a water-dispersible latex phase that contained 80 wt % of butadiene and had an average diameter of 1 μm was used instead of acrylonitrile-butadiene rubber(NBR).

### Example 16

A film was manufactured in the same manner as in Example 1, except that 20 parts by weight of metacrylate-butadiene styrene rubber (MBS) in a water-dispersible latex phase that contained 60 wt % of butadiene and had an average diameter of 1 μm was used instead of acrylonitrile-butadiene rubber (NBR).

### Example 17

A film was manufactured in the same manner as in Example 1, except that 20 parts by weight of water-dispersible metacrylate-butadiene styrene rubber (MBS) in a latex phase that contained 80 wt % of butadiene and had an average diameter of 1 μm was used instead of acrylonitrile-butadiene rubber (NBR).

### Example 18

A film was manufactured in the same manner as in Example 1, except that 20 parts by weight of water-dispersible metacrylate-butadiene styrene rubber (MBS) in a latex phase that contained 60 wt % of butadiene and had an average diameter of 1 μm was used instead of acrylonitrile-butadiene rubber (NBR).

### Comparative Example 1

A film was manufactured in the same manner as in Example 1, except that no rubber particles were mixed with polyvinyl chloride particles.

### Comparative Example 2

100 parts by weight of polyvinyl chloride that had an average degree of polymerization of 1,000 was mixed with 25 parts by weight of acrylonitrile-butadiene rubber (NBR) that contained 80 wt % of butadiene, 50 parts by weight of dioctylphthalate (DOP) used as primary plasticizer, 20 parts by weight of 2,2,4-trimethyl-1,3-pentanediol diisobutyrate (2,2,4-trimethyl-1,3-pentanediol diisobutyrate; TXIB) used as second plasticizer, and 3 parts by weight of a metal salt based thermal stabilizer (Zinc Stearate, Songwon Industrial Co. Ltd, SZ210), and then uniformly dispersed using a mixer. Then, the mixed product was stirred in the mixer at 150° C. Then, primary mixing and secondary mixing of the stirred product were performed using a roll at 150° C., and then a calendar was used to obtain a film having a thickness of 0.4 mm.

Performance Tests-Elasticity Test)

Tensile Strength and Elongation Tests

Tensile strength and elongation of the films prepared according to Examples 1-18 and Comparative Examples 1-2 were measured based on a method of ASTM D 412-98a. The results are shown in Table 1.

Recovery Rate Test

Each of the films prepared according to Examples 1-18 and Comparative Examples 1-2 was cut to a size of 1 cm (width) and 10 cm (length). Then, the resultant films were extended to 20 cm in the length direction and then maintained in the extended state for 3 minutes. Subsequently, the application of the tensile strength was stopped and the films were allowed to recover for 5 minutes. A recovery rate that is a ratio to the original state of the film was measured and is shown in Table 1.

Equation 1

Recovery Rate=(Original Lenght (10cm)/Recovered Length)×100

TABLE 1

| | Resin Composition | | | | | | |
|---|---|---|---|---|---|---|---|
| | Polyvinyl | | | | | | |
| | Chloride | | Rubber | | Elasticity Properties | | |
| | Content | | Content | Butadiene | Tensile | | |
| | (parts by | | (parts by | Content | Strength | Elongation | Recovery |
| Section | weight) | Rubber | weight) | (wt %) | (Mpa) | (%) | Rate (%) |
| Example 1 | 100 | NBR | 10 | 60 | 12 | 600 | 95 |
| Example 2 | 100 | NBR | 10 | 60 | 12 | 600 | 95 |
| Example 3 | 100 | NBR | 10 | 60 | 12 | 580 | 92 |
| Example 4 | 100 | NBR | 10 | 80 | 11 | 650 | 92 |
| Example 5 | 100 | NBR | 20 | 60 | 10 | 700 | 96 |
| Example 6 | 100 | NBR | 20 | 80 | 9 | 730 | 95 |
| Example 7 | 100 | NBR | 5 | 60 | 13 | 480 | 85 |
| Example 8 | 100 | NBR | 30 | 60 | 9 | 750 | 95 |
| Example 9 | 100 | SBR | 10 | 60 | 13 | 550 | 93 |
| Example 10 | 100 | SBR | 10 | 80 | 12 | 580 | 91 |
| Example 11 | 100 | SBR | 20 | 60 | 11 | 610 | 94 |
| Example 12 | 100 | SBR | 20 | 80 | 10 | 640 | 92 |
| Example 13 | 100 | SBR | 5 | 60 | 13 | 440 | 82 |
| Example 14 | 100 | MBS | 10 | 60 | 12 | 580 | 95 |
| Example 15 | 100 | MBS | 10 | 80 | 12 | 620 | 93 |
| Example 16 | 100 | MBS | 20 | 60 | 11 | 680 | 95 |
| Example 17 | 100 | MBS | 20 | 80 | 10 | 700 | 94 |
| Example 18 | 100 | MBS | 5 | 60 | 13 | 440 | 84 |
| Comparative | 100 | — | — | — | 14 | 400 | 80 |
| Example 1 | | | | | | | |
| Comparative | 100 | NBR | 25 | 80 | 10 | 300 | 85 |
| Example 2 | | | | | | | |

As shown in Table 1, the films prepared using the compositions according to Examples 1 through 18 showed properties of high elongation and large recovery rate, and thus excellent elasticity of the films was identified. In addition, the elasticity of the films was dependent on the amount of butadiene contained in the rubber of the corresponding composition, and thus, proper selection can be made based on use.

Such excellent elasticity may stem from excellent uniformity of the compositions due to mixing of polyvinyl chloride and rubber in a water-dispersible latex phase, and not mixing of polyvinyl chloride and rubber in powder or bulk state while being heat treated.

The film prepared according to Comparative Example 2 in which polyvinyl chloride powder was mixed with rubber powder showed properties of low elongation and low recovery rate, whereas the maximum elongation and recovery rate of the films prepared according to Examples 1 through 18 was higher than that of the film prepared according to Comparative Example 2 by an amount in a range of 430% and 11%.

### Examples 19-23

Each of 1, 2, 3, 4 and 5 parts by weight, respectively corresponding to examples 19 though 23, of potassiumethylxanthate (PEX) that contained 36 wt % of butadiene and had an average diameter of 0.2 μm were added to 100 parts by weight of acrylonitrile-butadiene rubber (NBR) to perform a crosslinking treatment.

100 parts by weight of solid content of primary polyvinyl chloride particles that had an average degree of polymerization of 1,000 and an average diameter of 1 μm were mixed with 20 parts by weight of the cross-linked acrylonitrile-butadiene rubber (NBR) described above, in a water-dispersible phase, and then the resultant mixture was dried using a spray dry method. As a result, secondary polyvinyl chloride particles having an average diameter of 10-50 μm were obtained. Among the films prepared according to Examples 1-18, more excellent properties were obtained when the content of rubber that contained 60 wt % of butadiene was 20 parts by weight based on 100 parts by weight of the solid content of polyvinyl chloride in the compositions in which rubbers were mixed in a water-dispersible state. In Examples and Comparative Examples, which will now be described, the additive effects of the crosslinking agents were identified using acrylonitrile-butadiene rubber, styrene-butadiene rubber, and metacrylate-butadiene-styrene rubber, each of which contained 50 wt % of butadiene as in Example 5, Example 11, and Example 16. Thereafter, 100 parts by weight of secondary polyvinyl chloride particles, 80 parts by weight of dioctylphthalate (DOP) used as primary plasticizer, 20 parts by weight of 2,2,4-trimethyl-1,3-pentanediol diisobutyrate(2,2,4-trimethyl-1,3-pentanediol diisobutyrate, TXIB) used as secondary plasticizer, and 3 parts by weight of metal based thermal stabilizer(Zinc Stearate, Songwon Industrial Co., Ltd, SZ210) were uniformly mixed using a mixer for 10 minutes, thereby obtaining a plastisol.

The plastisol was coated on a separator to a thickness of 0.4 mm, and then heat treated in an oven at 200° C. for 1 minute to form a film.

### Examples 24-28

Secondary polyvinyl chloride particles and films using the same were prepared in the same manner as in Example 19, except that 1, 2, 3, 4, and 5 parts by weight, respectively corresponding to examples 24 though 28, of gammamercaptoxypropyl-trimetoxysilane(MPTMS) based on 100 parts by weight of acrylonitrile-butadiene rubber(NBR) were respectively added to perform a crosslinking treatment.

### Examples 29-33

Films were manufactured in the same manner as in Examples 19-23, except that 20 parts by weight of styrene-butadiene rubber (SBR) in a water-dispersible latex phase that contained 60 wt % of butadiene was used instead of acrylonitrile-butadiene rubber (NBR).

### Examples 34-38

Films were manufactured in the same manner as in Examples 24-28, except that 20 parts by weight of styrene-butadiene rubber (SBR) in a water-dispersible latex phase that contained 60 wt % of butadiene was used instead of acrylonitrile-butadiene rubber (NBR).

### Examples 39-43

Films were manufactured in the same manner as in Examples 19-23, except that 20 parts by weight of metacrylate-butadiene-styrene rubber (MBS) in a water-dispersible latex phase that contained 60 wt % of butadiene was used instead of acrylonitrile-butadiene rubber (NBR).

### Examples 44-48

Films were manufactured in the same manner as in Examples 24-28, except that 20 parts by weight of metacrylate-butadiene-styrene rubber (MBS) in a water-dispersible latex phase that contained 60 wt % of butadiene was used instead of acrylonitrile-butadiene rubber (NBR).

### Comparative Example 3

A film was manufactured in the same manner as in Example 19, except that 100 parts by weight of secondary polyvinyl chloride particles that was prepared by mixing primary polyvinyl chloride particles with 20 parts by weight of acrylonitrile-butadiene rubber (NBR) particles that was not subjected to a cross linking treatment was used.

### Comparative Example 4

A film was manufactured in the same manner as in Example 19, except that 100 parts by weight of secondary polyvinyl chloride particles that was prepared by mixing primary polyvinyl chloride particles with 20 parts by weight of styrene-butadiene rubber (SBR) particles that was not subjected to a cross linking treatment was used.

### Comparative Example 5

A film was manufactured in the same manner as in Example 19, except that 100 parts by weight of secondary polyvinyl chloride particles that was prepared by mixing primary polyvinyl chloride particles with 20 parts by weight of metacrylate-butadiene-styrene rubber (MBS) particles that was not subjected to a cross linking treatment was used.

### Comparative Example 6

A film was manufactured in the same manner as in Example 19, except that 100 parts by weight of secondary polyvinyl chloride particles that was prepared by mixing primary polyvinyl chloride particles with no rubber particles was used.

(Performance Test-Elasticity Test)

Tensile Strength, Elongation, and Recovery rate of the films prepared according to Examples 19-48 and Comparative Examples 3-6 were measured.

(Performance Test-Processability Test)

Process Viscosity Test

Viscosity of plastisols prepared according to Examples 19-48 and Comparative Examples 3-6 was measured using a Brook Field viscometer LV type, #3 spindle at 25° C.

TABLE 2

| | Resin Composition | | | | | | | | |
|---|---|---|---|---|---|---|---|---|---|
| | | | | | Cross- | | | | |
| | | | | | Linking | | | | |
| | Polyvinyl | | Rubber | | Agent | | | | |
| | Chloride | | Content | Rubber | Content | Elasticity Properties | | | Processability |
| | Content | | (parts | Cross- | (parts | Tensile | | Recovery | Process |
| | (parts by | | by | Linking | by | Strength | Elongation | Rate | Viscosity |
| Section | weight) | Rubber | weight | Agent | weight) | (MPa) | (%) | (%) | (cps) |
| Example | 100 | NBR | 20 | PEX | 0.2 | 10 | 710 | 96 | 5500 |
| 19 | | | | | | | | | |
| Example | 100 | NBR | 20 | PEX | 0.4 | 12 | 730 | 95 | 1600 |
| 20 | | | | | | | | | |
| Example | 100 | NBR | 20 | PEX | 0.6 | 12 | 710 | 93 | 1500 |
| 21 | | | | | | | | | |
| Example | 100 | NBR | 20 | PEX | 0.8 | 12 | 680 | 91 | 1500 |
| 22 | | | | | | | | | |
| Example | 100 | NBR | 20 | PEX | 1.0 | 13 | 610 | 86 | 1500 |
| 23 | | | | | | | | | |
| Example | 100 | NBR | 20 | MPTMS | 0.2 | 9 | 700 | 96 | 6000 |
| 24 | | | | | | | | | |
| Example | 100 | NBR | 20 | MPTMS | 0.4 | 9 | 710 | 96 | 5400 |
| 25 | | | | | | | | | |
| Example | 100 | NBR | 20 | MPTMS | 0.6 | 10 | 690 | 96 | 4800 |
| 26 | | | | | | | | | |
| Example | 100 | NBR | 20 | MPTMS | 0.8 | 11 | 680 | 95 | 4500 |
| 27 | | | | | | | | | |
| Example | 100 | NBR | 20 | MPTMS | 1.0 | 11 | 660 | 94 | 4200 |
| 28 | | | | | | | | | |
| Example | 100 | SBR | 20 | PEX | 0.2 | 11 | 620 | 94 | 5200 |
| 29 | | | | | | | | | |
| Example | 100 | SBR | 20 | PEX | 0.4 | 11 | 640 | 95 | 3800 |
| 30 | | | | | | | | | |
| Example | 100 | SBR | 20 | PEX | 0.6 | 11 | 630 | 95 | 2700 |
| 31 | | | | | | | | | |
| Example | 100 | SBR | 20 | PEX | 0.8 | 11 | 590 | 93 | 2000 |
| 32 | | | | | | | | | |
| Example | 100 | SBR | 20 | PEX | 1.0 | 12 | 520 | 89 | 2100 |
| 33 | | | | | | | | | |
| Example | 100 | SBR | 20 | MPTMS | 0.2 | 11 | 600 | 94 | 5900 |
| 34 | | | | | | | | | |
| Example | 100 | SBR | 20 | MPTMS | 0.4 | 11 | 610 | 95 | 5500 |
| 35 | | | | | | | | | |
| Example | 100 | SBR | 20 | MPTMS | 0.6 | 11 | 620 | 94 | 4900 |
| 36 | | | | | | | | | |
| Example | 100 | SBR | 20 | MPTMS | 0.8 | 11 | 600 | 94 | 5200 |
| 37 | | | | | | | | | |
| Example | 100 | SBR | 20 | MPTMS | 1.0 | 11 | 580 | 92 | 5100 |
| 38 | | | | | | | | | |
| Example | 100 | MBS | 20 | PEX | 0.2 | 11 | 680 | 95 | 5800 |
| 39 | | | | | | | | | |
| Example | 100 | MBS | 20 | PEX | 0.4 | 12 | 690 | 95 | 5600 |
| 40 | | | | | | | | | |
| Example | 100 | MBS | 20 | PEX | 0.6 | 12 | 690 | 96 | 3200 |
| 41 | | | | | | | | | |
| Example | 100 | MBS | 20 | PEX | 0.8 | 12 | 650 | 93 | 2700 |
| 42 | | | | | | | | | |
| Example | 100 | MBS | 20 | PEX | 1.0 | 12 | 610 | 89 | 3000 |
| 43 | | | | | | | | | |
| Example | 100 | MBS | 20 | MPTMS | 0.2 | 12 | 670 | 95 | 6000 |
| 44 | | | | | | | | | |
| Example | 100 | MBS | 20 | MPTMS | 0.4 | 12 | 680 | 95 | 5800 |
| 45 | | | | | | | | | |
| Example | 100 | MBS | 20 | MPTMS | 0.6 | 12 | 680 | 95 | 5300 |
| 46 | | | | | | | | | |
| Example | 100 | MBS | 20 | MPTMS | 0.8 | 12 | 660 | 94 | 5200 |
| 47 | | | | | | | | | |
| Example | 100 | MBS | 20 | MPTMS | 1.0 | 12 | 630 | 91 | 5200 |
| 48 | | | | | | | | | |
| Comparative | 100 | NBR | 20 | — | 0 | 10 | 700 | 96 | 15000 |
| Example 3 | | | | | | | | | |
| Comparative | 100 | NBR | 20 | — | 0 | 11 | 610 | 94 | 9500 |
| Example 4 | | | | | | | | | |
| Comparative | 100 | NBR | 20 | — | 0 | 11 | 680 | 95 | 12000 |
| Example 5 | | | | | | | | | |
| Comparative | 100 | | 0 | — | 0 | 14 | 400 | 80 | 700 |
| Example 6 | | | | | | | | | |

PEX: potassiumethylxanthate,
MPTMS: gammamercaptosipropyltrimetoxysilane
SO: styreneoxazoline,
process viscosity: plastisol viscosity

As shown in Table 2, the films prepared according to Examples 19-48 in which secondary polyvinyl chloride particles formed by mixing polyvinyl chloride particles with cross-linked rubber particles were used showed tensile strength greater than or equal to the film prepared according to Comparative Example 3 in which secondary polyvinyl chloride particles formed by mixing polyvinyl chloride particles with rubber particles that were not subjected to a crosslinking treatment were used.

The elongation and recovery rate of the films prepared according to Examples 19-48 were higher than those of the film prepared according to Comparative Example 6 in which no rubber particles were mixed, and almost equal to or slightly higher than those of the film prepared according to Comparative Examples 3-5.

The process viscosity of the films prepared according to Examples 20-23 was somewhat higher than that of the film prepared according to Comparative Example 6 in which no rubber particles were added, but such process viscosity is within a process condition of 500-2000 cps. In addition, the process viscosity of the films prepared according to Examples 20-23 was substantially lower than the films prepared according to Comparative Examples 3-5 in which secondary polyvinyl chloride particles were prepared by mixing primary polyvinyl chloride particles with rubber particles that were not subjected to a crosslinking treatment. As a result, the processability of the films prepared according to Examples 20-23 was substantially increased. The kind of the crosslinking agent used can be selected according to the kind of rubber particles and a functional group contained in the crosslinking agent.

According to the present invention, highly elasticicty products having high elongation and large tensile strength can be produced by using a polyvinyl chloride composition. When a film is formed using the polyvinyl chloride composition, viscosity of the composition can be increased using an increased amount of plasticizer. As a result, the polyvinyl chloride composition shows excellent processability.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A highly elastic polyvinyl chloride composition comprising polyvinyl chloride-rubber particles, the polyvinyl chloride-rubber particles comprising:
secondary polyvinyl chloride particles formed by combination of primary polyvinyl chloride particles; and
rubber particles, wherein
the rubber particles fill pores between primary polyvinyl chloride particles that form secondary polyvinyl chloride particles.

2. The highly elastic polyvinyl chloride composition of claim 1, wherein the polyvinyl chloride-rubber particles are obtained by mixing 100 parts by weight of polyvinyl chloride particles in a water-dispersible latex phase with 1-30 parts by weight of rubber particles in a water-dispersible latex phase and then drying the resultant mixture.

3. The highly elastic polyvinyl chloride composition of claim 1, wherein an average degree of polymerization of the polyvinyl chloride particles is in the range of 100 to 3,000.

4. The highly elastic polyvinyl chloride composition of claim 1, wherein an average diameter of the primary polyvinyl chloride particles is in the range of 0.1 -2 μm.

5. The highly elastic polyvinyl chloride composition of claim 1, wherein the polyvinyl chloride particles are obtained from a vinyl chloride monomer or a mixed monomer including vinyl chloride and another monomer that can be copolymerized with the vinyl chloride.

6. The highly elastic polyvinyl chloride composition of claim 5, wherein the other monomer comprises at least one compound selected from the group consisting of acylic acid, metacrylic acid, alpha-cyanoacrylic acid, methylacrylate, ethylacrylate, butylacrylate, octylacrylate, cyanoethylacrylate, vinylacetate, methylmetacrylate, ethylmetacrylate, butylmetacrylate, acrylo nitrile, metacrylonitrile, methylacrylamide, N-methylacrylamide, N-butoxymetacrylamide, ethylvinylether, chloro-ethylvinylether, alpha-methylstyrene, vinyltoluene, chlorostyrene, vinylnaphthalene, vinylidenechloride, vinylbromide, vinylchloroacetate, vinylacetate, vinylpyridine, and methylvinylketone.

7. The highly elastic polyvinyl chloride composition of claim 1, wherein the rubber particles are selected from the group consisting of styrene-butadiene rubber (SBR), acrylonitrile-butadiene rubber (NBR), metacrylate-butadiene-styrene rubber (MBS), and a mixture of these.

8. The highly elastic polyvinyl chloride composition of claim 7, wherein the content of butadiene in the styrene-butadiene rubber (SBR) is in the range of 60-90 wt %.

9. The highly elastic polyvinyl chloride composition of claim 7, wherein the content of butadiene in the acrylonitrile-butadiene rubber(NBR) is in the range of 50-90 wt %.

10. The highly elastic polyvinyl chloride composition of claim 9, wherein the acrylonitrile-butadiene rubber (NBR) further comprises 1-10 parts by weight of a monomer having a carboxylic group based on 100 parts by weight of the total content of acrylonitrile and butadiene.

11. The highly elastic polyvinyl chloride composition of claim 7, wherein the content of metacrylate and butadiene in the metacrylate-butadiene-styrene rubber (MBS) are in the ranges of 5-30 wt % and 60-90 wt %, respectively.

12. The highly elastic polyvinyl chloride composition of claim 1, wherein an average degree of polymerization of the rubber particles is in the range of 100-3,000.

13. The highly elastic polyvinyl chloride composition of claim 1, wherein the average diameter of the rubber particles is in the range of 0.05-1 μm.

14. The highly elastic polyvinyl chloride composition of claim 1, further comprising 80-100 parts by weight of a plasticizer based on 100 parts by weight of polyvinyl chloride-rubber particles.

15. The highly elastic polyvinyl chloride composition of claim 14, wherein the plasticizer comprises 70-90 wt % of a primary plasticizer and 10-30 w % of a secondary plasticizer.

16. The highly elastic polyvinyl chloride composition of claim 15, wherein the primary plasticizer comprises at least one compound selected from the group consisting of dioctyl phthalate, diisononyl phthalate, and butylbenzyl phthalate, and the secondary plasticizer comprises at least one compound selected from the group consisting of 2,2,4-trimethyl-1,3-pentanediol diisobutyrate, a mixture of 1-phenyl-1-xylethane and 1-phenyl-1-ethylphenylethane, polyether modified polydimethylsiloxane copolymer, and dioctylphthalate.

17. The highly elastic polyvinyl chloride composition of claim 1, wherein the rubber particles are subjected to a crosslinking treatment using a crosslinking agent.

18. The highly elastic polyvinyl chloride composition of claim 17, wherein the crosslinking treatment is performed by adding 0.5-10 parts by weight of a solid content of the crosslinking agent to 100 parts by weight of a solid content of the rubber particles in a latex phase at a temperature in a range of 10° C. to 95° C. and stirring the products of the reaction.

19. The highly elastic polyvinyl chloride composition of claim 17, wherein the crosslinking agent comprises at least one compound selected from the group consisting of trimethylolpropane-trimetacrylate, triarylcyanurate, triarylisocyanurate, N,N′-metaphenylenedimaleimide, ethyleneglycoldimetacrylate, vinyl-1,2-polybutadiene, 1,1-t-butylperoxy-3,3,5-trimethylcyclohexane, n-butyl-4,4-bisbutylperoxyvalerate, dicumylperoxide, benzoylperoxide, t-butylperoxybenzoate, di-t-butylperoxide, 2,5-dimethyl-2,5-di-t-butylperoxyhexane, paraquinonedioxin, dibenzoylparaquinonedioxin, tetrachloroparabenzoquinone, hexamethylenetetramine, acetaldehydeammonia, butylaldehydeammonia, butylaldehyde butylanyline, acetaldehyde anyline, diphenylguanidine, diorthotolylguanidine, orthotolylbiguanidine, N,N′-diethylthiourea, dibutylthiourea, diraurylthiourea, trimethyl-thiourea, mercaptobenzothiazole, dibenzothiazyldisulfide, sodium-2-mercapto-benzothiazole, tetramethylthiurammonosulfide, tetramethyltetramethylthiuramdisulfide, tetraethylthiuramdisulfide, tetrabutylthiuramdisulfide, dipentamethylene-thiuramtetrasulfide, sodiumdimethyldithiocarbamate, sodiumdibutyldithio-carbamate, zincdimethyldithiocarbamate, zincdiethyldithiocarbamate, pericdimethyldithiocarbamate, cupperdimethyldithiocarbamate, zincethylphenyldithiocarbamate, zincdibutyldithiocarbamate, zincbutylxanthate, zincisopropyixanthate, zincethylxanthate, sodiumisopropylxanthate, sodiumethylxanthate, potassiumethylxanthate, potassiumisopropylxanthate, N-cyclohexyl-2-benzothiazolylsufenamide, N-t-butyl-2-benzothiazolyl-sulfenamide, N-oxydiethylene-2-benzothiazoylsulfenamide, zinc oxide, zinc carbonate, magnesium oxide, plumbum monooxide, potassium hydrate, stearinic acid, oleic acid, lauric acid, stearinic acid zinc, dibutylamoniumolate, vinyltrimetoxysilane, vinyltri-etoxysilane, vinyl-tri-(2-methoxyethoxysilane), vinyltriacetoxysilane, gammamercaptoxypropyltrimetoxysilane, gammamercaptotri-(2-methoxyethoxysilane), gammaglycyldylpropyltrimetoxysilane, gammamercaptopropyltriethoxysilane, gammaaminopropyltrimetoxysilane, gammaaminopropyltrimetoxysilane, aminoalkylsilicone, styreneoxazoline, and 2-methyloxazoline.

20. The highly elastic polyvinyl chloride composition of claim 17, wherein the viscosity of the highly elastic polyvinyl chloride composition is in the range of 500-6,000 cps at 25° C.

21. The highly elastic polyvinyl chloride composition of claim 1, wherein an average diameter of the polyvinyl chloride-rubber particles is in the range of 10-50 μm.

22. A product prepared using highly elastic polyvinyl chloride composition, the polyvinyl chloride-rubber particles comprising:
secondary polyvinyl chloride particles formed by combination of primary polyvinyl chloride particles; and
rubber particles, wherein
the rubber particles fill pores between primary polyvinyl chloride particles that form secondary polyvinyl chloride particles.

23. The product of claim 22, being a film, a sheet, or a tile.
